(19) United States
(12) Patent Application Publication
(10) Pub. No.: US 2025/0318523 A1
(43) Pub. Date: Oct. 16, 2025

(54) Use of Pinenes to Improve Localized Insecticide Injections Targeting Western Drywood Termite (Blattodea: Kalotermitidae)

(71) Applicant: THE REGENTS OF THE UNIVERSITY OF CALIFORNIA, Oakland, CA (US)

(72) Inventors: Dong-Hwan Choe, Riverside, CA (US); Nicholas Poulos, Riverside, CA (US); Chow-Yang Lee, Riverside, CA (US); Michael Rust, Riverside, CA (US)

(73) Assignee: THE REGENTS OF THE UNIVERSITY OF CALIFORNIA, Oakland, CA (US)

(21) Appl. No.: 19/175,300

(22) Filed: Apr. 10, 2025

Related U.S. Application Data
(60) Provisional application No. 63/632,298, filed on Apr. 10, 2024.

(51) Int. Cl. A01N 27/00; A01N 43/36; A01N 43/56; A01N 43/80; A01N 47/44; A01P 7/04

(52) U.S. Cl. CPC A01N 27/00; A01N 43/36; A01N 43/56; A01N 43/80; A01N 47/44; A01P 7/04

(57) ABSTRACT

A method to improve a localized insecticide, which includes adding a pinene to the localized insecticide. The pinene being α-pinene or β-pinene.

### CROSS REFERENCE TO RELATED APPLICATIONS

This application claims the benefit of U.S. Provisional Application No. 63/632,298, filed Apr. 10, 2024, which is incorporated by reference in its entirety.

### TECHNICAL FIELD

The present disclosure generally relates to use of pinenes to improve localized insecticide injections targeting the western drywood termite (Blattodea: Kalotermitidae), and more particularly, a preventive or remedial use of injectable termiticide formulations targeting wood-destroying drywood termites in structures.

### BACKGROUND

The western drywood termite, Incisitermes minor (Hagen) (Blattodea: Kalotermitidae) (hereinafter “I. minor”), causes significant economic damage in its native range of the southwestern United States and northwestern Mexico. Beyond its native range, I. minor has spread to other parts of the United States as far east as Florida, and it is also found in Hawaii, Canada, China, Japan, and Australia. Increased urbanization and globalization involving the movement of wood and wood-containing products worldwide, along with the cryptic lifestyle of I. minor, contribute to its status as an important structural pest in several parts of the world. Western drywood termites typically nest and forage inside one piece of wood (or pieces that contact), with only winged reproductive (alates) leaving the nest for dispersal, making their detection and management challenging.

Remedial control options for drywood termite infestations can be categorized as whole-structure or localized treatment. Whole-structure treatment targets all infestations in a structure at once, while localized treatment targets infestations limited to single boards or a small group of boards. Structural fumigation with sulfuryl fluoride is the most common method for whole-structure treatment. However, structural fumigation for drywood termite control has several drawbacks, including its high cost, disruptiveness (in California, structural fumigators must implement the California Aeration Plan), and the lack of residual protection. In addition, sulfuryl fluoride is classified as a significant greenhouse gas, and its use for structural fumigation might undergo more regulatory scrutiny in the future.

When infestations are relatively small and readily accessible, localized insecticide injection, also known as “drill-and-treat” or “spot” treatment, is a useful control option with residual protection. The “drill-and-treat” or “spot” treatment involves injecting insecticides into infested wood through evenly spaced drill holes (often in a diamond pattern), some of which might intersect existing termite galleries. Since the termites must contact or ingest the injected insecticide to be killed, the success of localized insecticide injection largely depends upon the ability to locate active infestations within the structure. However, even when one or few drill holes successfully intersect the existing termite gallery, extensive gallery systems in mature colonies of the drywood termite and its aggregation behavior in certain parts of the galleries might limit the injected insecticide from reaching all the termites at lethal doses, substantially impacting control efficacy. The possibility of leaving pockets of survivors and subsequent reestablishment of an infestation is one of the most common concerns for the localized insecticide injection method.

The concept of attract-and-kill may have the potential to provide a solution for this challenge. The attract-and-kill method involves applying a pheromone or other chemical attractant and an insecticide (killing agent). The attractant lures the target insect pest to the insecticide deposit, and the insect picks up a lethal dose upon contact. If the locally injected insecticide deposits can attract drywood termites from a distance (within their gallery), control efficacy might be maximized even when the injection does not provide complete coverage of the target termite gallery system. To test this idea, it is important to find effective attractants that would lure termites away from their aggregations to treated areas, increasing the overall exposure level of the termite colony to the insecticide residue.

Galleries of mature I. minor colonies are typically found in the sapwood of dry, sound wood (without decay). Differences in physical and chemical characteristics between sapwood and heartwood might be responsible for this apparent preference. Based on a series of choice tests involving ten different kinds of timbers, it was concluded that sapwood and heartwood of Norway spruce were most preferred by I. minor workers (pseudergates). Their choice feeding data also indicated a slight trend of preference for the sapwood of Norway spruce over its heartwood. It has also been reported that founding I. minor reproductive preferred the sapwood over the heartwood of Sitka spruce for their initial colonization. Since Sitka spruce heartwood does not show any deterrence effect on I. minor, these observations suggest that I. minor's preference for sapwood over heartwood of spruce timber (Picea spp.) is possibly related to the presence of attractant(s) in the sapwood rather than the presence of deterrent(s) or repellent(s) in the heartwood.

Based on an aeration study investigating the total volatile organic compound (TVOC) concentration of sapwood and heartwood, it has been reported that sapwood of Norway spruce (P. abies) releases 2-3 times more TVOC than its heartwood. Two volatile monoterpenes, α-pinene, and β-pinene, are the most abundant organic compounds found in the headspace of Norway spruce. The volatiles of Norway spruce sapwood contained more α-pinene than those of heartwood while β-pinene was present only in the sapwood volatiles. A similar finding with Norway spruce using solid-phase microextraction (SPME) combined with gas chromatography-mass spectrometry (GC/MS) has also been reported.

### SUMMARY

In this disclosure, the inventors tested if treatment with α- or β-pinene could affect the behavior of I. minor workers within simulated wooden gallery systems. By developing channel arena and T-maze arena assays, the inventors explored if α- or β-pinene added to specific parts of the wooden gallery could lure I. minor workers away from their existing aggregation, increasing the chance of contacting the treated area. Based on the initial behavioral investigation, the inventors also tested the incorporation of α- or β-pinene with selected insecticide residues, which would affect mortality trends in I. minor colonies and overall control efficacy compared to the insecticide-only standard treatments.

When infestations by drywood termites are relatively small and readily accessible, localized insecticide injection, also known as “drill-and-treat” or “spot” treatment, is a useful control option with residual protection. As set forth, the “drill-and-treat” or “spot” treatment involves injecting insecticides into infested wood through evenly spaced drill holes (often in a diamond pattern), some of which might intersect existing termite galleries. However, even when one or few drill holes successfully intersect the existing termite gallery, extensive gallery systems in mature colonies of the drywood termite and its aggregation behavior in certain parts of the galleries might limit the injected insecticide from reaching all the termites at lethal doses, substantially impacting control efficacy. The possibility of leaving pockets of survivors and subsequent reestablishment of an infestation is one of the most common concerns for the localized insecticide injection method.

The current disclosure addresses this challenge by incorporating small amount of pinenes in the injected insecticides to influence the drywood termite behavior. The small amounts of pinenes applied within the arenas caused I. minor to move away from their initial aggregations and contact the treated areas. The efficacy of aqueous insecticide treatment was significantly improved by adding one of the pinenes. The termites were killed more quickly, and the final mortality was higher in the pinene+insecticide treatment than the insecticide-only treatment. Incorporating an attractant, such as pinene, in localized insecticide injection could allow for wider spacing between drill holes without negatively impacting the efficacy of the treatment. Consequently, this invention may also help improve the cost-effectiveness of localized insecticide injections by reducing the time and labor needed for the treatment. Additionally, it is possible that the incorporation of an attractant such as pinene for localized insecticide injection could also help reduce the amount of insecticide product needed to achieve a desirable level of control.

In accordance with an embodiment, a method to improve a localized insecticide comprising: adding a pinene to the localized insecticide

In accordance with another embodiment, a method of using injectable termiticide formulations targeting wood-destroying drywood termites comprising: adding a pinene to an injectable termiticide formulation; and injecting the injectable termiticide formulation with the added pinene into a termite infested wood.

In accordance with a further embodiment, a formulation for targeting wood-destroying drywood termites comprising: an injectable termiticide formulation; and a pinene, the pinene being α-pinene or β-pinene.

### BRIEF DESCRIPTION OF DRAWINGS

FIG. 1 illustrates a channel arena and wherein a piece of cotton ball was used to confine the termites to a 5-cm section of the channel for 24 hour establishing the initial-aggregation zone (A). An approximately 6-cm section of the treatment zone (B) was used to apply a pinene dissolved in methanol (or methanol only for control). An approximately 1-cm section at the end of the treatment zone (C) shows the area where insecticide treatments were made for the insecticide bioassays.

FIG. 2 is an assembled T-maze showing approximate arrangement of internal tunnels.

FIG. 3 illustrates percent (mean±SEM) I. minor found in the treatment zone of the channel following treatment with solvent only (control), α-pinene or β-pinene. Bars with different letters are statistically different from each other (α=0.05; Dunn all-pairwise comparison)

FIG. 4 illustrates percent (mean±SEM) I. minor found in choice blocks of the T-maze. The treated block received a treatment with solvent only (graph A), α-pinene (graph B), or β-pinene (graph C). The asterisk indicates a statistically significant difference (α=0.05; Wilcoxon signed-rank test).

FIG. 5 are Kaplan-Meier survival curves of I. minor from fipronil insecticide bioassay. Data from the methanol-only served as control (without insecticide).

FIG. 6 illustrates percent (+SE) mortality of I. minor from fipronil insecticide bioassay at day 14. Data from the methanol-only served as control (without insecticide). Bars with different letters are statistically different from each other (α=0.05; Tukey's test).

### DETAILED DESCRIPTION

### Materials and Methods

Termites. Western drywood termites, I. minor, were extracted from several pieces of infested wood collected in Riverside, CA. Each colony was stored in a plastic container (30.5 by 21.6 by 6.4 cm) with small pieces of basswood (150 by 100 by 3.2 mm; Midwest Products Co., Inc., Darien, IL) as a food source. A couple of small openings were made on the sides of the containers for ventilation, and the containers were placed within a larger plastic box (40.6 cm by 22.9 cm by 27.9 cm) containing a saturated NaCl solution to maintain 75% relative humidity (RH) within the larger box (Winston and Bates 1960). The stock colony boxes were kept in a growth chamber (Thermo Fisher Scientific, Waltham, MA) at 26° C. without light. To minimize the chance of using termites that were damaged during the collection process, the collected termites were left undisturbed for at least 7 days (d), and the surviving termites at the end of this period were used in the experiments. One or two different populations were randomly chosen to set up each experimental trial. Only worker termites (approximately 5 mm in length) were used for the experiments.

Chemicals. Two monoterpenes, α-pinene (98%, Sigma-Aldrich, St. Louis, MO) and (−)-β-pinene (>99%, Sigma-Aldrich), were individually tested for their effects on drywood termite behavior. Methanol was used to dissolve the pinenes at 0.1 mg/mL concentration. Clean methanol served as a solvent-only control.

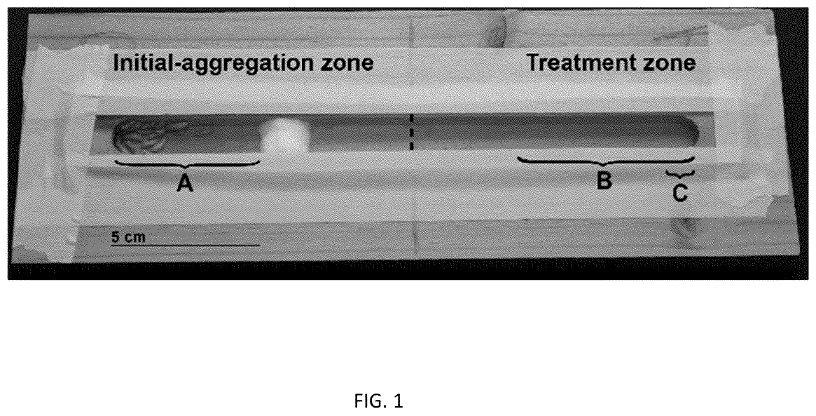

Channel Arena Bioassay. A channel arena was developed to examine the behavioral effect of α-pinene and β-pinene on a group of I. minor within a simplified termite gallery system. It was made from two-by-four Douglas fir boards (25 cm by 8.9 cm by 3.81 cm). Each board was cut in half horizontally, producing two flat pieces (top and bottom) with identical dimensions (25 cm by 8.9 cm by 1.9 cm). A channel (19.8 cm by 1.3 cm, 0.6 cm in depth) was routed in the bottom piece along the centerline, simulating a termite gallery (FIG. 1). A strip of clear acrylic sheet (2.5 cm by 22 cm by 0.2 cm) was held in place over the channel with masking tape, permitting observation of the termites in the channel. The top piece of the arena was placed on top of the acrylic panel to keep the channel dark during the experiment.

To establish the “initial-aggregation zone,” twenty termites were confined to a 5-cm zone at one end of the channel for 24 hours (h) using a cotton plug (FIG. 1). After establishing the initial-aggregation zone, 100 μL of the methanol preparation containing a pinene (either α- or β-pinene) or clean methanol was applied to the opposite end of the channel (average spread of 6 cm). This resulted in an application rate of 1.3 μg/cm2 for α- or β-pinene. The half of the channel containing this treated area served as the “treatment zone” (FIG. 1). After the solvent evaporated for 3 minutes (min), the cotton plug was removed, and the arenas were assembled. The arenas were maintained at approximately 22° C.-23° C. and less than (<) 20%-66% RH in complete darkness. After 24 hours (h), the number of termites in the treatment zone was counted under red light (110 lux, Tacklife; Levittown, NY) to minimize any disruption to the termites during observation (Cabrera and Rust 1996). Each of the treatments and control were replicated 10 times.

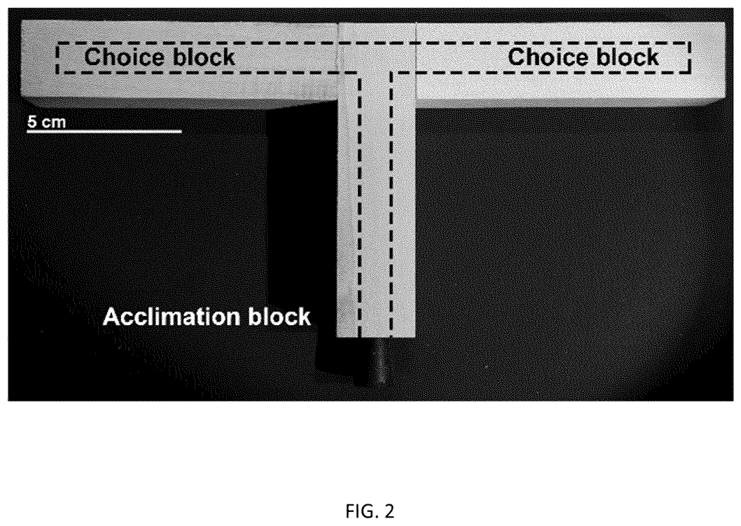

T-maze Bioassay. A T-maze bioassay was developed to study the effects of α- or β-pinene on the choice behavior of I. minor within a simplified termite gallery system. The T-maze consisted of three basswood blocks (2.54 cm by 2.54 cm by 10.16 cm). One block served as a central acclimation block, while the other two served as lateral choice blocks (FIG. 2). All blocks were drilled along the centerline to form longitudinal tunnels (8.9 cm in depth, 0.95 cm in diameter), which ended near the opposite end of the block (about 1.2 cm away from the opposite end of the block). For the acclimation block, a through hole (0.95 cm in diameter) was drilled to add a cross tunnel, perpendicularly intersecting the longitudinal tunnel at its closed end. This cross tunnel provided connection points between the acclimation block and two choice blocks.

Twenty termites from the stock colony were placed in the tunnel of the acclimation block and confined there for 24 hours (h) by sealing the holes with rubber stoppers. Two choice blocks were randomly assigned for treatment (treated block) or no treatment (untreated block). The furthest end of the gallery in the treated block was treated with 100 μL of methanol preparations (0.1 mg/mL α- or β-pinene) or clean methanol (solvent-only control) using a glass microcapillary tube (Drummond Scientific Company, Broomall, PA) while positioning the block vertically during the treatment. The treated block was left to dry for 5 minutes. After removing the two rubber stoppers from the cross tunnel of the acclimation block, the treated and untreated choice blocks were connected to the acclimation block using a double-sided working tape (Hippie Crafter, Miami Beach, FL). The T-mazes were stored in a growth chamber at 26° C. and 20%-26% RH in complete darkness. After 24 hours, T-mazes were disassembled, and numbers of termites in each of the three blocks (two choice blocks and one acclimation block) were recorded. Treatments and solvent-only control were replicated 10 times. The positions of the treated and untreated blocks alternated for each replication.

Insecticide Bioassay. The effect of pinenes on the efficacy of insecticide residue was evaluated using the channel arena bioassay design (FIG. 2). Even though the T-maze would simulate slightly more complex gallery systems than the channel arena, the latter was selected for the insecticide bioassay due to its advantage of permitting repeated observations of termites over time without the need of disassembling the arena. The experimental protocol was identical to the method previously described for the channel arena bioassay except for applying an insecticide product at the end of the treatment zone (FIG. 2).

The following insecticide product was used in the experiment: Termidor SC (9.1% fipronil; BASF, Research Triangle, NC). This product was selected based on a laboratory study showing relatively high efficacy for drywood termite control (Rust and Venturina 2008). This product is currently registered for drywood termite control.

For fipronil, 10 μL of 0.06% aqueous suspension was applied in a small area (1.43 cm²) at the end of the treatment zone using a glass microcapillary tube and allowed to dry. Simultaneously, the termites were confined in the initial-aggregation zone. After 24 hours, the methanol preparation of α-pinene or β-pinene was applied at the end of the treatment zone and allowed to dry for 3 minutes. Subsequently, the cotton plug in the channel was removed and the entire arena was assembled. The 24-hour drying period for the treatment zone was necessary to avoid uncontrolled effects that water (from aqueous fipronil preparation) might have on termite behavior.

Two different control groups were included in the experimental design: one without insecticide, and the other with insecticide. Both control groups received clean methanol only (no pinene). The arenas were maintained at approximately 22° C.-23° C. and <20-66% RH in complete darkness. Observations were made under red light every 24 hours for 14 days. Termites were recorded as dead (no movement) or alive. Each treatment and control were replicated 9 times to 14 times.

Statistical Analyses. All count data were converted to percentage values for analyses. Data from the channel arena bioassay did not meet the homogeneity of variance assumptions. Thus, the percentage data were compared between solvent only and the pinene treatments with a Kruskal-Wallis test followed by Dunn posthoc all-pairwise comparisons. Treatment data from the T-maze bioassay (percentage of termites found in the untreated and treated blocks) failed to meet normality and homogeneity of variance assumptions. Therefore, a Wilcoxon signed-rank test was used to compare the data between the untreated and treated blocks. The data were first analyzed with a Kaplan-Meier survival analysis for the insecticide bioassays. The distribution of survival times of termites was described using the survivorship function S (t), the probability of an individual termite surviving past a given time point, t (in days). Log-rank tests were used for overall comparisons among survival curves and subsequent multiple comparisons using the Holm-Sidak method. The final cumulative mortality data (day 14) were first normalized using an arcsin square-root transformation and subsequently analyzed with a one-way analysis of variance (ANOVA) followed by Tukey's test. All statistical analyses were performed in Sigma Plot version 14.5 (Systat Software, San Jose, CA).

### Results

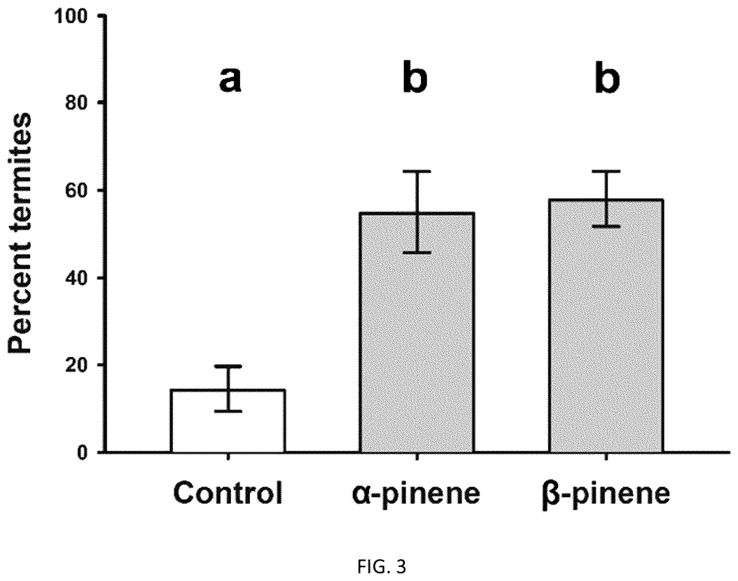

Channel Arena Bioassay. When methanol was used for treatment, 14.5±5.1% (mean±SEM) of termites were found in the treatment zone after 24 hours. In contrast, 55±9.3 or 58±6.3% of termites were found in the treatment zone when it was treated with α- or β-pinene, respectively (FIG. 3) (Kruskal-Wallis test: H=14.40; df=2; P<0.0001). Dunn's pairwise comparisons showed that the percentage of termites in the treatment zone from α-pinene and β-pinene treatments were significantly different from that of solvent only (Z=3.07; P=0.002 for α-pinene and Z=3.44; P<0.001 for β-pinene). However, data from α-pinene and β-pinene treatments were not significantly different from each other (Z=0.37; P=0.712).

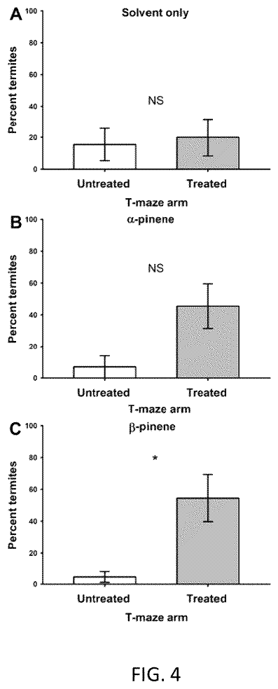

T-maze Bioassay. When methanol was used to treat one of the choice blocks, similar numbers of termites were found in the untreated and treated blocks of the maze at 24 h (Wilcoxon signed-rank test: W=3; P=0.844). On average, 15.5±10.2 and 20±11.8% of the termites were found in the untreated and treated blocks, respectively (FIG. 4, graph A). When α-pinene was used to treat one of the choice blocks, 7.0±7.0 and 45.5±14.1% of the termites were found in the untreated and treated blocks, respectively (FIG. 4, graph B). However, the difference was not statistically significant (Wilcoxon signed-rank test: W=19; P=0.063). When β-pinene was used for treatment, 4.5±3.5% of the termites were found in the untreated block, while 54.5±14.8% were found in the treated block. This difference was statistically significant (Wilcoxon signed-rank test: W=28; P=0.016) (FIG. 4, graph C).

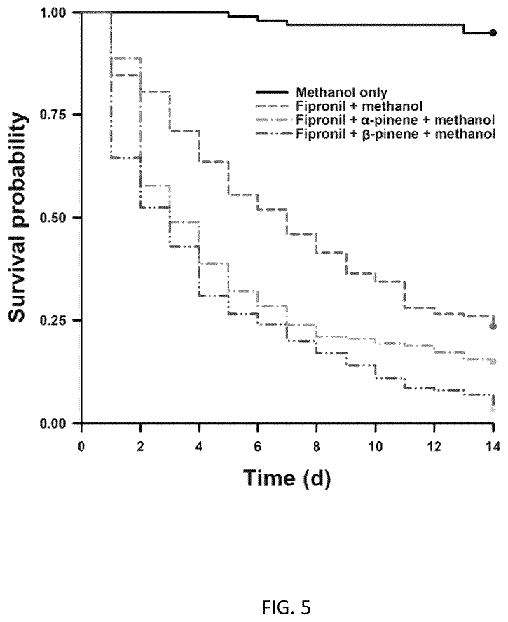

Insecticide Bioassay for Fipronil. Overall, a significant difference among the survival curves was found (log-rank test: χ2=249.39; df=3; P<0.001) (FIG. 5). Pairwise comparisons indicated all survival curves were significantly different from each other.

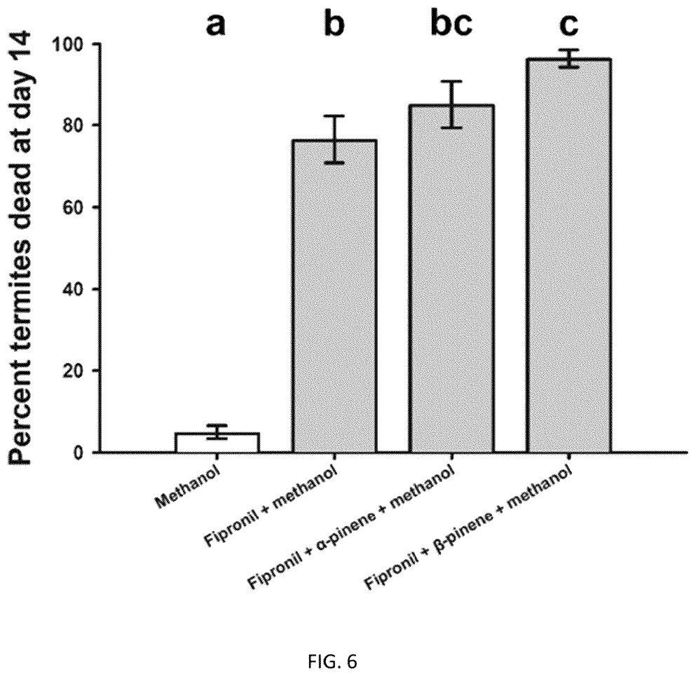

The final cumulative mortality levels differed among groups (ANOVA: F=37.91; df=3, 30; P<0.001) (FIG. 6). Between the treatments with pinene, only fipronil+β-pinene (96.5±2.1%) was significantly different from the fipronil only control (76.5±5.7%) (P=0.006). The difference between fipronil only and fipronil+α-pinene (85±5.7%) was not significant (P=0.593). The α- and β-pinene fipronil treatments had similar mortality levels (P=0.129). The solvent only control had 5.0±1.6% mortality, which was significantly different from all other treatments (FIG. 6).

The possibility of leaving pockets of survivors and subsequent reestablishment of an infestation is one of the most common concerns for the localized insecticide injection method.

Current invention addresses this challenge by incorporating small amount of pinenes in the injected insecticides to influence the drywood termite behavior. The small amounts of pinenes applied within the arenas caused I. minor to move away from their initial aggregations and contact the treated areas. The efficacy of aqueous insecticide treatment was significantly improved by adding one of the pinenes. The termites were killed more quickly, and the final mortality was higher in the pinene+insecticide treatment than the insecticide-only treatment. Incorporating an attractant, such as pinene, in localized insecticide injection could allow for wider spacing between drill holes without negatively impacting the efficacy of the treatment. Consequently, this invention may also help improve the cost-effectiveness of localized insecticide injections by reducing the time and labor needed for the treatment. Additionally, it is possible that the incorporation of an attractant such as pinene for localized insecticide injection could also help reduce the amount of insecticide product needed to achieve a desirable level of control.

Even though the current disclosure included one insecticide active ingredient (fipronil), this disclosure can be applied to other insecticide active ingredients [e.g., neonicotinoids (imidacloprid, dinotefuran, etc.), pyrroles (chlorfenapyr), isoxazolines (isocycloseram, fluralaner, etc.), etc.] or formulations (e.g., foam, dust, etc.).

The detailed description above describes embodiments of the use of pinenes to improve localized insecticide injections targeting the western drywood termite (Blattodea: Kalotermitidae), and more particularly, a preventive or remedial use of injectable termiticide formulations targeting wood-destroying drywood termites in structures. The invention is not limited, however, to the precise embodiments and variations described. Various changes, modifications and equivalents may occur to one skilled in the art without departing from the spirit and scope of the invention as defined in the accompanying claims. It is expressly intended that all such changes, modifications and equivalents which fall within the scope of the claims are embraced by the claims.

What is claimed is:

1. A method to improve a localized insecticide comprising:
adding a pinene to the localized insecticide.

2. The method according to claim 1, wherein the pinene is α-pinene.

3. The method according to claim 1, wherein the pinene is β-pinene.

4. The method according to claim 1, wherein the insecticide includes an active ingredient.

5. The method according to claim 4, wherein the active ingredient is fipronil.

6. The method according to claim 4, wherein the active ingredient is one or more of a neonicotinoid, a pyrrole, and an isoxazoline.

7. The method according to claim 6, wherein the neonicotinoid is imidacloprid or dinotefuran.

8. The method according to claim 6, wherein the pyrrole is chlorfenapyr.

9. The method according to claim 6, wherein the isoxazoline is isocycloseram or fluralaner.

10. The method according to claim 1, further comprising:
combining the pinene with the insecticide into a foam or a dust.

11. The method according to claim 1, further comprising:
dissolving the pinene in methanol to a concentration not to exceed 0.1 mg/mL.

12. A method of using injectable termiticide formulations targeting wood-destroying drywood termites comprising:
adding a pinene to an injectable termiticide formulation; and
injecting the injectable termiticide formulation with the added pinene into a termite infested wood.

13. The method according to claim 12, wherein the pinene is α-pinene or β-pinene.

14. The method according to claim 12, wherein the injectable termiticide formulation includes an active ingredient, the active ingredient being fipronil.

15. The method according to claim 12, wherein the injectable termiticide formulation includes an active ingredient, the active ingredient being a neonicotinoid, a pyrrole, or an isoxazoline.

16. The method according to claim 15, wherein the neonicotinoid is imidacloprid or dinotefuran, the pyrrole is chlorfenapyr, and the isoxazoline is isocycloseram or fluralaner.

17. The method according to claim 12, further comprising:
combining the pinene with the injectable termiticide formulation in a form of a foam or a dust.

18. A formulation for targeting wood-destroying drywood termites comprising:
an injectable termiticide formulation; and
a pinene, the pinene being α-pinene or β-pinene.

19. The method according to claim 12, wherein the injectable termiticide formulation includes an active ingredient, the active ingredient being fipronil.

20. The method according to claim 12, wherein the injectable termiticide formulation includes an active ingredient, the active ingredient being a neonicotinoid, a pyrrole, or an isoxazoline.
